(19) United States
(12) Patent Application Publication
(10) Pub. No.: US 2018/0181503 A1
(43) Pub. Date: Jun. 28, 2018

(54) DATA FLOW COMPUTATION USING FIFOS

(71) Applicant: Wave Computing, Inc., Campbell, CA (US)

(72) Inventor: Christopher John Nicol, Campbell, CA (US)

(21) Appl. No.: 15/904,724

(22) Filed: Feb. 26, 2018

Related U.S. Application Data
(63) Continuation-in-part of application No. 15/226,472, filed on Aug. 2, 2016.
(60) Provisional application No. 62/464,119, filed on Feb. 27, 2017.
(60) Provisional application No. 62/472,670, filed on Mar. 17, 2017.
(60) Provisional application No. 62/486,204, filed on Apr. 17, 2017.
(60) Provisional application No. 62/527,077, filed on Jun. 30, 2017.
(60) Provisional application No. 62/539,613, filed on Aug. 1, 2017.
(60) Provisional application No. 62/541,697, filed on Aug. 5, 2017.
(60) Provisional application No. 62/547,769, filed on Aug. 19, 2017.
(60) Provisional application No. 62/577,902, filed on Oct. 27, 2017.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/200,069, filed on Aug. 2, 2015.

(51) Int. Cl. G06F 13/16; G06F 15/80

(52) U.S. Cl. CPC G06F 13/1673; G06F 13/1689; G06F 2213/0064; G06F 15/80; G06F 13/1694

(57) ABSTRACT

Disclosed embodiments provide techniques for data manipulation with logic circuitry. One or more processing elements are reconfigured in a connected topology. The reconfiguring enables the implementation of a dataflow graph. A FIFO is dynamically configured between a pair of neighboring processing elements. The FIFO contains data and/or instructions for processing elements. A process agent executing on the processing element coordinates transfer of data to/from FIFOs and processing elements. The processing elements are controlled by circular buffers. The circular buffers are statically scheduled. Processing elements enter and exit a sleep mode based on data conditions of the interconnected FIFOs. The FIFOs are configured to minimize adverse effects of latency, while process agents issue and receive signals to enable synchronization between processing elements.

### RELATED APPLICATIONS

This application claims the benefit of U.S. provisional patent applications “Data Flow Computation Using FIFOs” Ser. No. 62/464,119, filed Feb. 27, 2017, “Fork Transfer of Data Between Multiple Agents Within a Reconfigurable Fabric” Ser. No. 62/472,670, filed Mar. 17, 2017, “Reconfigurable Processor Fabric Implementation Using Satisfiability Analysis” Ser. No. 62/486,204, filed Apr. 17, 2017, “Joining Data Within a Reconfigurable Fabric” Ser. No. 62/527,077, filed Jun. 30, 2017, “Remote Usage of Machine Learned Layers by a Second Machine Learning Construct” Ser. No. 62/539,613, filed Aug. 1, 2017, “Reconfigurable Fabric Operation Linkage” Ser. No. 62/541,697, filed Aug. 5, 2017, “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, and “Multithreaded Dataflow Processing Within a Reconfigurable Fabric” Ser. No. 62/611,600, filed Dec. 29, 2017.

This application is also a continuation-in-part of U.S. patent application “Data Transfer Circuitry Given Multiple Source Elements” Ser. No. 15/226,472, filed Aug. 2, 2016, which claims the benefit of U.S. provisional patent application “Data Uploading to Asynchronous Circuitry Using Circular Buffer Control” Ser. No. 62/200,069, filed Aug. 2, 2015.

Each of the foregoing applications is hereby incorporated by reference in its entirety.

### FIELD OF ART

This application relates generally to logic circuitry and more particularly to data flow computation using FIFOs.

### BACKGROUND

Many applications and businesses today rely on high-performance computing to accomplish their goals. In addition to computing power, flexibility is also important for adapting to ever-changing business and technical situations. The demand for increased computing power to implement newer electronic designs for a variety of applications such as computing, networking, communications, consumer electronics, and data encryption, is continuously growing in today's modern computing world. In addition to processing speed, configuration flexibility is a key attribute in modern computing systems. Multiple core processor designs enable two or more cores to run simultaneously, and the combined throughput of the multiple cores can exceed the processing power of a single-core processor. In accordance with Moore's Law, the multiple core capacity allows for an increase in capability of electronic devices without the limitations encountered when attempting to implement similar processing power using a single core processor.

In some architectures, multiple cores can work together to perform a particular task. In this case, the cores communicate with each other, exchange data, and combine data to produce intermediate and/or final outputs. Each core can have a variety of registers to support program execution and storage of intermediate data. Additionally, registers such as stack pointers, return addresses, and exception data can also enable execution of complex routines and can support debugging of computer programs running on the multiple cores. Furthermore, arithmetic units can provide mathematical functionality, such as addition, subtraction, multiplication, and division.

One such architecture for use with multiple cores is a mesh network. A mesh network is a network topology containing multiple interconnected processing elements. The processing elements work together to distribute and process data. This architecture allows a degree of parallelism for processing data which enables increased performance. Additionally, the mesh network allows for a variety of configurations.

Reconfigurability is an important attribute in many processing applications, as reconfigurable devices have proven extremely efficient for certain types of processing tasks There are cost and performance advantages of reconfigurable devices in certain circumstances because reconfigurable logic enables program parallelism, allowing for multiple simultaneous computation operations for the same program. Meanwhile, conventional processors are often limited by instruction bandwidth and execution restrictions. Often, the high-density properties of reconfigurable devices come at the expense of the high-diversity property that is inherent in microprocessors. Microprocessors have evolved to a highly-optimized configuration that can provide cost/performance advantages over reconfigurable arrays for certain tasks with high functional diversity. However, there are many tasks for which a conventional microprocessor may not be the best design choice. Other conventional computing techniques involve the use of application specific integrated circuits (ASICs)-circuits designed from the ground up with a specific application or implementation in mind. These ASICs can achieve high performance, but at the cost of extremely inflexible hardware design.

The emergence of reconfigurable computing has created a capability for both flexibility and performance of computer systems. Reconfigurable computing combines the high speed of application specific integrated circuits with the flexibility of programmable processors. This provides much-needed functionality and power to enable the technology in many current and upcoming fields.

### SUMMARY

Reconfigurable computing includes architectures that incorporate a combination of circuit techniques and coding techniques. The hardware within the reconfigurable architectures is efficiently designed and achieves high performance when compared to the performance of general purpose hardware. Further, these reconfigurable architectures can be adapted or “recoded” based on techniques similar to those used to modify software. That is, the reconfigurable architecture can be adapted by changing the code used to configure the elements of the architecture. A reconfigurable fabric is one such architecture that can be successfully used for reconfigurable computing. Reconfigurable fabrics can be coded to represent a variety of processing topologies. The topologies are coded to perform the many applications that require high performance computing. Applications such as processing of unstructured data, digital signal processing (DSP), machine learning, neural networks such as convolutional neural networks (CNN) and deep neural networks (DNN), and so on, are well served by the capabilities of a reconfigurable fabric. The capabilities of the reconfigurable fabric perform particularly well when the data includes specific types of data, large quantities of unstructured data, and so on. The reconfigurable fabric is configured by coding or scheduling the reconfigurable fabric to execute these and other processing techniques. The reconfigurable fabric can be scheduled to configure a variety of computer architectures that can perform various types of computations with high efficiency. The scheduling of the reconfigurable fabric can be changed based on a dataflow graph.

Disclosed techniques implement data manipulation with logic circuitry. Data manipulation within a reconfigurable fabric requires flexible data handling in order to provide efficient and scalable dataflow processing. Dynamically configuring FIFOs within the fabric provides an efficient use of fabric resources and powerful scaling capacity and can provide lower inter-processor latencies for reconfigurable fabric data manipulation. One or more processing elements are arranged in a connected topology. A FIFO is dynamically configured between a pair of neighboring processing elements. The FIFO contains data and/or instructions for processing elements. A process agent executing on the processing element coordinates the transfer of data between FIFOs and processing elements. Processing elements enter and exit a sleep mode based on data conditions of the interconnected FIFOs. The FIFOs are configured to minimize adverse effects of latency, while process agents issue and receive signals to enable synchronization between processing elements.

Embodiments include a processor-implemented method for data manipulation comprising: reconfiguring a plurality of processing elements to perform operations of a plurality of process agents wherein the plurality of process agents includes a first process agent assigned to a first processing element, a second process agent assigned to a second processing element, and a third process agent assigned to a third processing element; selecting a first size for a first FIFO memory element and a second size for a second FIFO memory element, wherein the selecting is based on the first process agent, the second process agent, and the third process agent; inserting the first FIFO between the first processing element and the second processing element; and inserting the second FIFO memory element between the second processing element and the third processing element. In embodiments, the plurality of processing elements comprise a dataflow processor. In embodiments, the plurality of processing elements comprise a reconfigurable fabric. Some embodiments further comprise transferring a first data quantity between the first processing element and the second processing element. Some embodiments further comprise transferring a second data quantity between the second processing element and the third processing element. In embodiments, the first FIFO enables synchronization between the first process agent and the second process agent, and the second FIFO enables synchronization between the second process agent and the third process agent.

Various features, aspects, and advantages of various embodiments will become more apparent from the further description that follows.

### BRIEF DESCRIPTION OF THE DRAWINGS

The following detailed description of certain embodiments may be understood by reference to the following figures wherein:

FIG. 1 is a flow diagram for data manipulation.

FIG. 2 is a flow diagram for process agent control.

FIG. 3 shows a pipeline of process agents.

FIG. 4 illustrates pseudocode for a process agent.

FIG. 5A shows an initial flow graph with a moveable agent.

FIG. 5B shows initial agent placement.

FIG. 6 illustrates managed agent placement and buffer allocation.

FIG. 7 shows scheduled sections relating to an agent.

FIG. 8 illustrates a server allocating FIFOs and processing elements.

FIG. 9 shows a cluster for coarse-grained reconfigurable processing.

FIG. 10 illustrates a block diagram of a circular buffer.

FIG. 11 illustrates a circular buffer and processing elements.

FIG. 12 is system diagram for implementing computational reconfiguration using FIFOs.

### DETAILED DESCRIPTION

Techniques are disclosed for managing data within a reconfigurable computing environment. In a multiple processing element environment, such as a mesh network, or other suitable topology, there is a need to pass data between processing elements. An agent executing in software on each processing element interacts with dynamically established first-in-first-out (FIFO) buffers to coordinate the flow of data. The size of each FIFO may be created at run-time based on latency and/or synchronization requirements for a particular application. Registers within each processing element track the starting address and ending address of each FIFO. In cases where there is no data present in a FIFO, a processing element can enter a sleep mode to save energy. When valid data arrives in a FIFO, a sleeping processing element can wake to process the data.

In a multiple processing element environment, multiple data paths may converge at a particular processing element. In such cases, it can be important to have the data from the multiple paths arrive at the converged node at a temporally proximal time. That is, the node (processing element) where the data from the multiple paths converges should be available within a predetermined time interval. If this does not happen, the converged node may starve and be forced to enter a waiting or sleep state (sleep mode) until the data arrives. Thus, measures to improve the probability of a temporally proximal arrival time of data at the converged node can improve overall system performance.

Based on the data consumption and data production rates of each processing element, an additional FIFO may be established between two processing elements. In some cases, a processing element may produce small amounts of data at low intervals, in which case no FIFO may be needed and the processing element can send the data directly to another processing element. In other cases, a processing element may produce large amounts of data at frequent intervals, in which case an additional FIFO can help streamline the flow of data. This can be particularly important with bursty data production and/or bursty data consumption. In some embodiments, the data may be divided into blocks of various sizes. Data blocks above a predetermined threshold may be deemed large blocks. For example, blocks greater than 512 bytes may be considered large blocks in some embodiments. Large data blocks may be routed amongst processing elements through FIFOs implemented as a memory element in external memory, while small data blocks (less than or equal to the predetermined threshold) may be passed amongst processing elements directly into onboard circular buffers without requiring a FIFO.

The dynamic creation of FIFOs of various sizes between processing elements at various points within a network of processing elements enables improved efficiency. It serves to minimize the amount of down time for processing elements, by allowing the processing elements to continue producing and/or consuming data as much as possible during operation of the multiple processing element computer system.

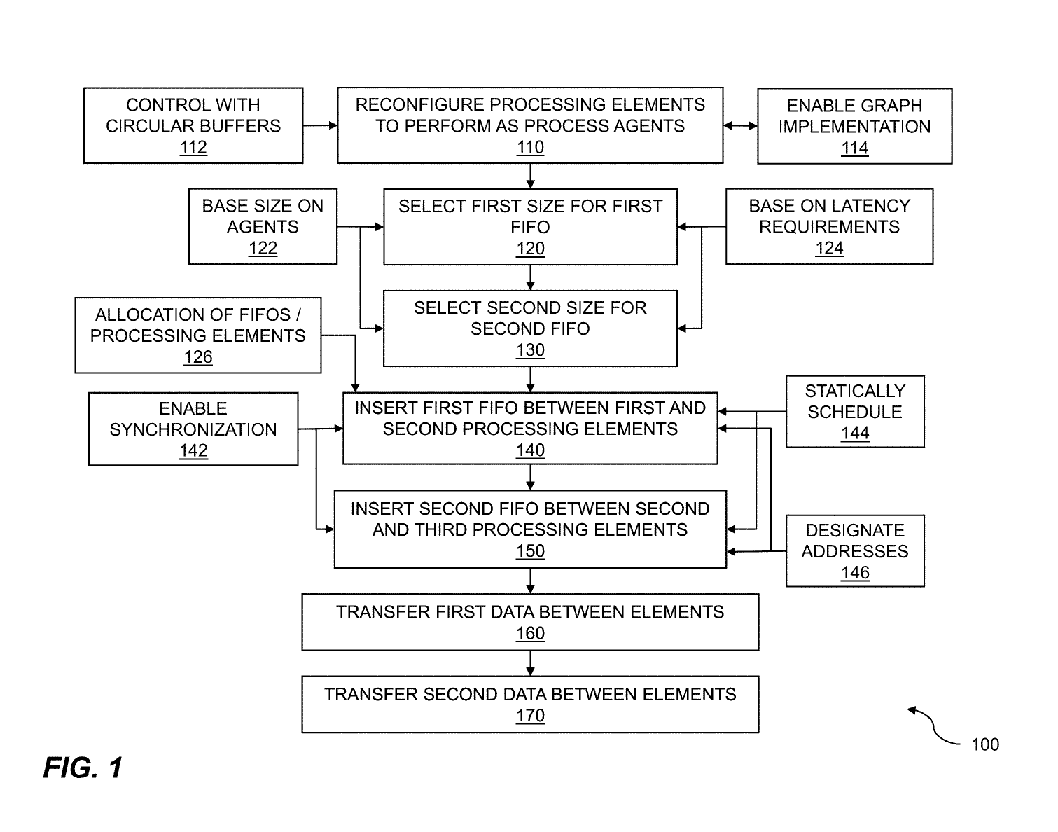

FIG. 1 is a flow diagram for data manipulation. In the flow 100, a processor-implemented method for data manipulation comprises: reconfiguring a plurality of processing elements to perform operations of a plurality of process agents 110. In embodiments, multiple processing elements are interconnected as a switched fabric or mesh topology. A process agent may execute on one or more processing elements. The process agent retrieves data from one or more FIFOs and outputs data to one or more FIFOs. In the flow 100, the plurality of process agents includes a first process agent assigned to a first processing element, a second process agent assigned to a second processing element, and a third process agent assigned to a third processing element.

The flow 100 includes allocation of FIFOs and processing elements 126. In embodiments, the allocation of FIFOs may come from an external memory bank. The processing elements may be allocated from a pool of available processing elements on one or more circuit boards installed within a box, where the box includes multiple circuit boards.

The flow 100 includes selecting a first size for a first FIFO memory element 120 and a second size for a second FIFO memory element 130, wherein the selecting is based on the first process agent, the second process agent, and the third process agent. The flow includes basing the FIFO size on the process agents 122. One criterion for FIFO size selection may be the consumption rate of the process agent. The consumption rate of the process agent pertains to the rate at which the process agent can read input data from a FIFO. The consumption rate can be related to the functions performed by a processing element. If a processing element performs minimal data manipulation, then the consumption rate may be relatively high. If a processing element performs more extensive data manipulation (e.g. more operations), it may be that the consumption rate then is relatively low. A lower consumption rate may warrant a larger input FIFO, whereas a higher consumption rate may allow for a smaller input FIFO, since the process agent removes data from the FIFO more quickly, and thus requires less memory.

Another criterion for the FIFO size selection includes the production rate of the process agent. The production rate of the process agent pertains to the rate at which the process agent can write input data to a FIFO. The production rate can be related to the functions performed by a processing element. If a processing element performs minimal data manipulation, then the production rate may be relatively high. If a processing element performs more extensive data manipulation (e.g. more operations) then the production rate may be relatively low. A lower production rate may allow for a smaller output FIFO, whereas a higher production rate may warrant a larger output FIFO. In the latter case since the process agent places data on the FIFO more quickly, more memory is required.

The flow 100 includes inserting the first FIFO between the first processing element and the second processing element 140. The flow 100 includes inserting the second FIFO memory element between the second processing element and the third processing element 150. The flow 100 includes transferring a first quantity of data between the first processing element and the second processing element 160. The flow 100 includes transferring a second quantity of data between the second processing element and the third processing element 170. The flow 100 can include designation of addresses 146. In embodiments, each processing element may store two addresses for each FIFO that its process agent accesses. One address is a starting address or “head” pointer. Another address is an ending address or “tail” pointer. In embodiments, the processing element may include a hardware register for storing the starting address and ending address. When a FIFO is inserted between a first processing element and a second processing element, both processing elements can synchronize the starting address registers and ending address registers of the FIFO. In embodiments, one processing element is a sending element and the other processing element is a receiving element. The sending processing element may send data to the receiving processing element to indicate the starting address and ending address. As the sending processing element puts data on the FIFO, it may adjust the starting address register. As the receiving processing element removes data from the FIFO, it may adjust the ending address register.

The flow can include basing the FIFO size on latency requirements 124. In some embodiments, multiple data paths may converge at a particular processing element. In such cases, it can be important to have the data from the multiple paths arrive at a temporally proximal time at the converged node. That is, the node (processing element) where the data from the multiple paths converges should be available within a predetermined time interval. The size of the FIFO can affect the arrival time of data at a particular processing element. In some embodiments, it may be helpful to increase a size of the FIFO for one of the converging data paths while using a smaller sized FIFO for another converging data path to allow data to arrive within a predetermined time interval. This allows the processing element receiving data from multiple converging data paths to operate efficiently, thus reducing the amount of idleness due to data starvation.

In some embodiments, a FIFO is an input FIFO for one process agent on one processing element, and that same FIFO is an output FIFO for another process agent on a neighboring processing element. Thus, one processing element can pass data to another processing element using the FIFO. In some embodiments, the FIFO is a read/write FIFO. In such embodiments, data is both read from and written to the FIFO by a process agent. In such embodiments, information in the data such as packet headers may be used to identify the source and destination of the data. In yet other embodiments, there can be two FIFOs between each processing element where one FIFO is an input FIFO and another is an output FIFO.

The FIFO size can have a variable width. In some cases, the FIFO entry width can vary on an entry by entry basis. Depending on the type of data read from and written to the FIFO, a different width can be selected in order to optimize FIFO usage. For example, 8-bit data would fit more naturally in a narrower FIFO. Likewise, 32-bit data would fit more naturally in a wider FIFO. The FIFO width may also account for tags, metadata, pointers, and so on. The width of the FIFO entry can be encoded in the data that will flow through the FIFO. In this manner, the FIFO width size may change based on the encoding. In embodiments, the FIFO size includes a variable width. In embodiments, the width is encoded in the data flowing through the FIFO.

In the flow 100, the first data and the second data can be the same. This can occur when one or more processing elements are performing a buffering operation. In the flow 100, the first data and the second data can be different. This is the more typical scenario, where multiple processing elements each receive data from an upstream processing element, change that data or create new data based on the received data, and pass the new or changed data to a downstream processing element.

In the flow 100, the first size and the second size can be the same, or the first size and the second size can be different. In some embodiments, the first size is bigger based on latency requirements of the first process agent and the second process agent. In some embodiments, the second size is bigger based on latency requirements of the second process agent and the third process agent.

In the flow 100, the first FIFO enables synchronization 142 between the first and second process agents. In the flow 100, the second FIFO enables synchronization 142 between the second process agent and the third process agent. The synchronization can be based on start instructions stored in circular buffers.

The flow 100 includes enabling implementation of a dataflow graph 114. The dataflow graph can be an intermediate representation of a design. The dataflow graph may be processed as an input by an automated tool such as a compiler. The output of the compiler may include instructions for reconfiguring processing elements to perform as process agents. The reconfiguring can also include insertion of a FIFO between two processing elements of a plurality of processing elements.

In the flow 100, the plurality of processing elements are controlled with circular buffers 112. A given computational circuit can include multiple circular buffers and multiple circuits or logical elements. The circuits can include computational elements, communications paths, storage, and other circuit elements. Each circular buffer can be loaded with a page of instructions which configures the digital circuit operated upon by the instructions in the circular buffer. When and if a digital circuit is required to be reconfigured, a different page of instructions can be loaded into the circular buffer and can overwrite the previous page of instructions that was in the circular buffer. A given circular buffer and the circuit element controlled by the circular buffer can operate independently from other circular buffers and their concomitant circuit elements. The circular buffers and circuit elements can operate in an asynchronous manner. That is, the circular buffers and circuit elements can be self-clocked, self-timed, etc., and require no additional clock signal. Further, swapping out one page of instructions for another page of instructions does not require a retiming of the circuit elements. The circular buffers and circuit elements can operate as hum circuits, where a hum circuit is an asynchronous circuit which operates at its own resonant or “hum” frequency. In embodiments, each of the plurality of processing elements can be controlled by a unique circular buffer. In the flow 100, circular buffers are statically scheduled 144. Thus, in some cases, the initial configuration of the circular buffers may be established at compile time.

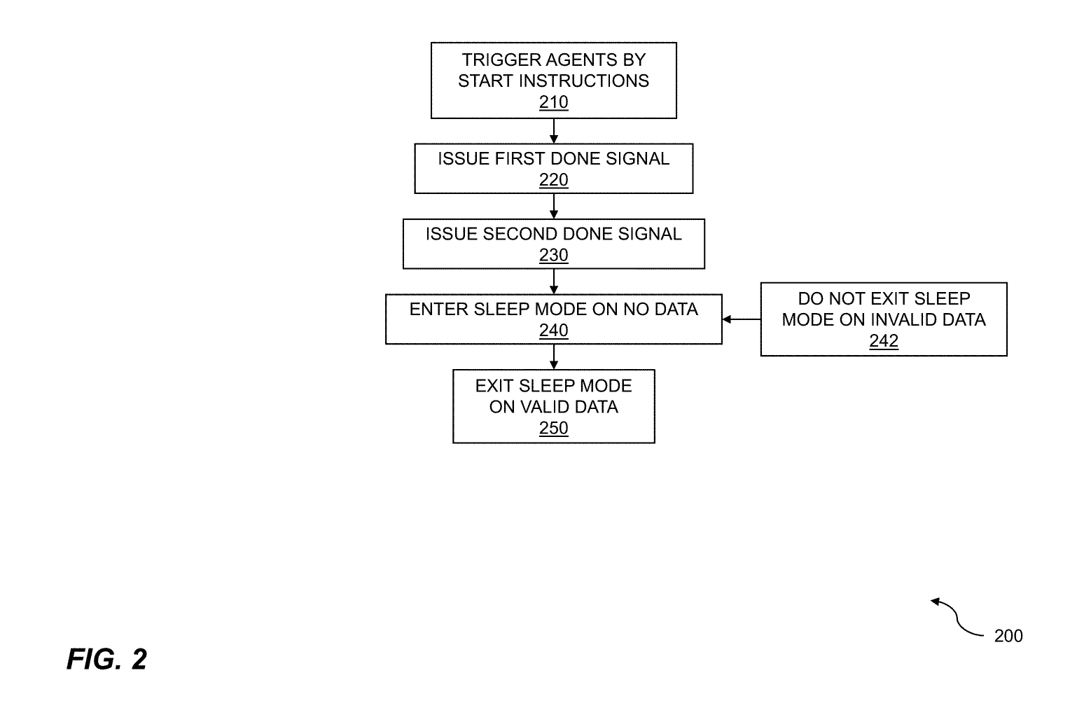

FIG. 2 is a flow diagram for process agent control. In the flow 200, the plurality of process agents is triggered by start instructions which are stored in circular buffers 210. In embodiments, an agent may be started by a processing element upon receipt of a particular instruction stored in a circular buffer. In some embodiments, the process agent may be initialized and kept in a waiting state, anticipating the start instruction to transition into an active state.

The flow 200 continues with issuing a first done signal 220. This can occur when a process agent empties a FIFO by reading its contents. Once that happens, the process agent may issue a first done signal to the upstream agent. In embodiments, the first done signal may be a dedicated hardware Input/Output (I/O) signal between two processing elements. In other embodiments, the first done signal may be an instruction passed directly to a circular buffer of an upstream processing element. In a similar manner, the flow 200 continues with issuing a second done signal 230. This can occur when a downstream process agent empties a FIFO by reading its contents. Once that happens, the downstream process agent may issue a second done signal to the process agent. In embodiments, the second done signal may be a dedicated hardware Input/Output (I/O) signal between two processing elements. In other embodiments, the second done signal may be an instruction passed directly to a circular buffer of an upstream processing element.

In the flow 200, the processing elements enter a sleep mode when there is no data to transfer 240. This can serve to reduce power consumption of a fabric or mesh network of processing elements. When the processing elements have no data to receive from the associated FIFO, the processing element can enter a sleep state. The sleep state may be a state of reduced activity, reduced clock speed, reduced voltage, or another reduced state that mitigates power consumption while in the sleep state. However, the processing element is still sufficient to detect a wake condition such that the sleep state can be exited at an appropriate time.

In the flow 200, the processing elements exit the sleep mode when presented with valid data 250. The sleep mode can be a low power mode. In some embodiments, one bit within each data word may be designated as a valid bit. When a processing element is in the sleep mode and receives data with the valid bit set, it can cause the processing element to enter the awake state which allows resumption of normal operations including execution of a process agent. In the flow 200, the processing elements do not exit the sleep mode when presented with invalid data 242. For example, if data is presented to processing elements but the valid bit is not set for the data, then the processing elements do not exit the sleep mode.

In some embodiments, another mechanism may be used to indicate data validity. In some embodiments, Null Convention Logic (NCL) circuitry may be used to send data between processing elements. Null Convention Logic (NCL) includes transistor circuits having a plurality of input/output lines, each with an asserted state and a null state.

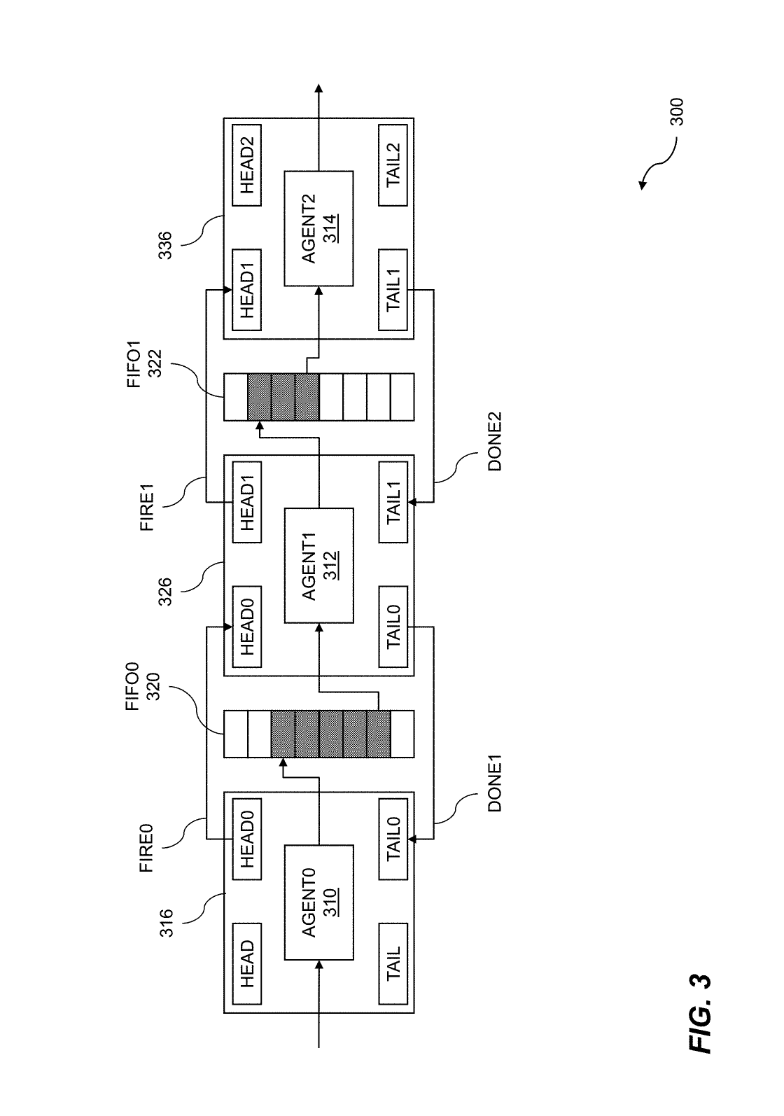

FIG. 3 shows an example 300 with a pipeline of process agents. The example 300 includes a first processing element 316, a second processing element 326, and a third processing element 336. A first process agent 310 executes on processing element 316. A second process agent 312 executes on processing element 326. A third process agent 314 executes on processing element 336. A first FIFO 320 (FIFO0) is configured between processing element 316 and processing element 326. In some embodiments, data may flow from processing element 316 to FIFO0 320, and then to processing element 326. A second FIFO 322 (FIFO1) is configured between processing element 326 and processing element 336. In some embodiments, data may flow from processing element 326 to FIFO1 322, and then to processing element 336. The HEAD0 register of processing element 316 and the HEAD0 register of processing element 326 may be synchronized to each point to a starting address of FIFO0 320. The HEAD1 register of processing element 326 and the HEAD1 register of processing element 336 may be synchronized to each point to a starting address of FIFO1 322. FIFO0 320 and FIFO1 322 may be of different sizes. As indicated in FIG. 3, FIFO0 is allocated to include five blocks of memory (indicated by shaded blocks within FIFO0 320) and FIFO1 is allocated to include three blocks of memory (indicated by shaded blocks within FIFO1 322). Thus, the first size and the second size can be different. The first size can be bigger based on latency requirements of the first process agent and the second process agent. The second size can be bigger based on latency requirements of the second process agent and the third process agent. A first data unit can be transferred between the first processing element and the second processing element. The second processing element may use the first data unit as an input to an operation that produces a result (e.g. a logical XOR operation). The result can be a second data unit. A second data unit can be transferred between the second processing element and the third processing element.

In the diagram 300, the FIFOs can comprise blocks of memory designated by starting addresses and ending addresses. The respective HEAD and TAIL registers/pointers of each processing element can be configured to reference the starting and ending addresses respectively. The starting addresses and the ending addresses can be stored with instructions in circular buffers. In embodiments, as agents execute on the processing elements and place data in a FIFO or remove data from a FIFO, a corresponding read and write pointer or register is updated to refer to the next location to be read to or written from. In embodiments, as agents execute on the processing elements and place data on a FIFO or remove data from a FIFO, the head and/or tail pointer/register is updated to refer to the next location to be read from or written to.

The first FIFO can enable synchronization between the first and second process agents. The second FIFO can enable synchronization between the second process agent and the third process agent. In embodiments, signaling between the processing elements can be used to enable synchronization. The second process agent can issue a first done signal to the first process agent when the second process agent has completed a first data transfer out of the first FIFO. Similarly, the third process agent can issue a second done signal to the second process agent when the third process agent has completed a second data transfer out of the second FIFO.

Synchronization can also be enabled using fire signals. The first process agent can issue a first fire signal to the second process agent when the first process agent has completed a first data transfer into the first FIFO. Similarly, the second process agent can issue a second fire signal to the third process agent when the second process agent has completed a second data transfer into the second FIFO.

In the diagram 300 AGENT1 312 receives data from 310 AGENT0 310 through FIFO0 320 and delivers data to AGENT2 314 through FIFO1 322. Thus, AGENT1 is seen to have one input stream and one output stream. In embodiments, AGENT1 can have an additional input stream from AGENT3 (not shown) through an additional FIFO (not shown) in similar manner to the input stream from AGENT0 310 through FIFO0 320 already described. In this case, AGENT1 312 can wait for valid data to be present in both of its input FIFOs before commencing operation. AGENT1 312 can wait for sufficient space on its output FIFO1 322 before commencing operation. In embodiments, AGENT3 comprises a fourth processing element. In embodiments, a third data unit can be transferred from a fourth processing element to a second processing element. In embodiments, data transfer into a processing element with two input streams is suspended until data on both input streams is valid. In embodiments, data transfer into a processing element with two input streams is suspended until space exists on an output FIFO.

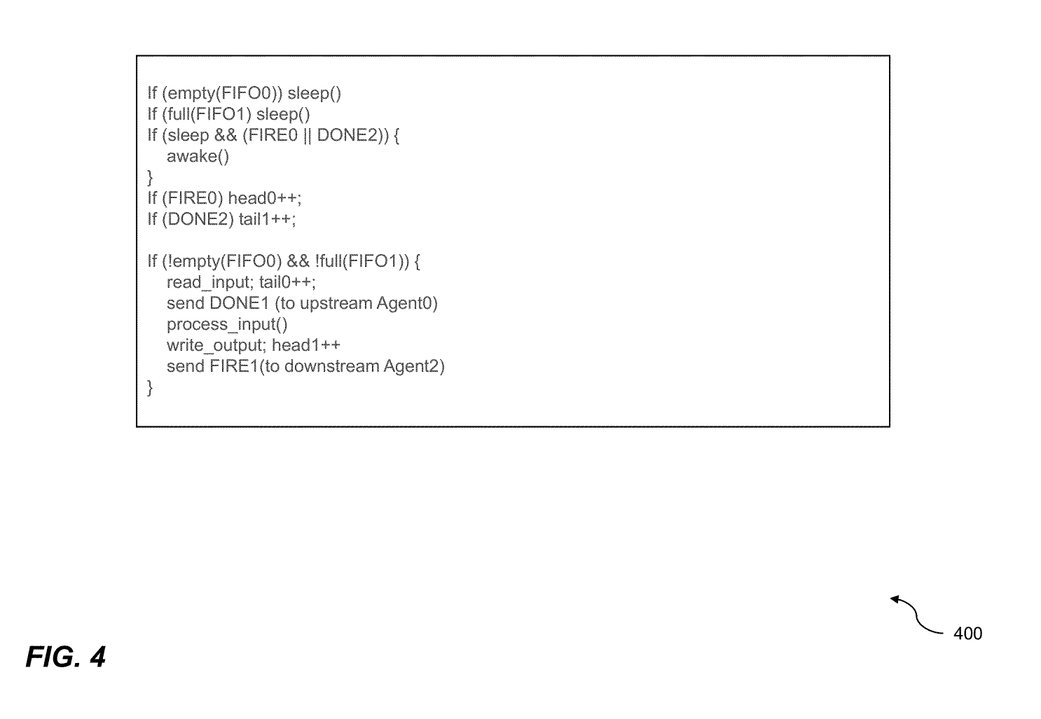

FIG. 4 illustrates an example 400 of pseudocode for a process agent. A plurality of process agents can be triggered by start instructions stored in circular buffers. The processing element, upon detecting a start instruction, can invoke the process agent to begin sending data to and receiving data from FIFOs, and can enable synchronization between neighboring processing elements. The pseudocode can include logic for checking if an input FIFO is empty and for entering a sleep mode if the input FIFO is empty. Thus, in the example of FIG. 3, processing element 326 can enter a sleep mode if FIFO0 320 is empty. The sleep mode can be a low power mode. The low power mode can be a mode which operates at a reduced clock speed and/or reduced voltage. The pseudocode can include logic for checking if an output FIFO is full, and for entering a sleep mode if the output FIFO is full. Thus, in the example of FIG. 3, processing element 326 can enter a sleep mode if FIFO1 322 is full. The pseudocode can include logic to check for the presence of a FIRE signal or DONE signal and to transition from a sleep mode to an awake state upon detecting such a condition. Thus, in the example of FIG. 3, processing element 326 can transition to the awake state from a sleep mode upon detecting an asserted FIRE0 signal originating from processing element 316, which indicates that new data is available in FIFO0 320. Similarly, processing element 326 can transition to the awake state from a sleep state upon detecting an asserted DONE2 signal originating from processing element 336, which indicates that processing element 336 is ready to accept data placed in FIFO1 322. The pseudocode can include logic for incrementing a head/tail pointer/register based on the presence of a FIRE signal or DONE signal.

The pseudocode can further include logic for recording performance information. The performance information can later be used by tools such as compilers, and/or interpreted by engineers to make improvements in a reconfigurable processing network. For example, the performance information can include, but is not limited to, average sleep mode percentage, average sleep mode percentage due to input FIFO empty, and average sleep mode percentage due to output FIFO full. In this way, as a reconfigurable fabric is used with live data, the statistics can be studied to determine if additional adjustments can further optimize performance. As an example, an output FIFO size may be increased if it is determined that a processing element is spending considerable time in sleep mode due to the output FIFO being full. In some embodiments, the reconfigurable processing network may be simulated on one or more computers, and the results of the simulation may be used to further optimize the selection of FIFO sizes used in the actual hardware platform.

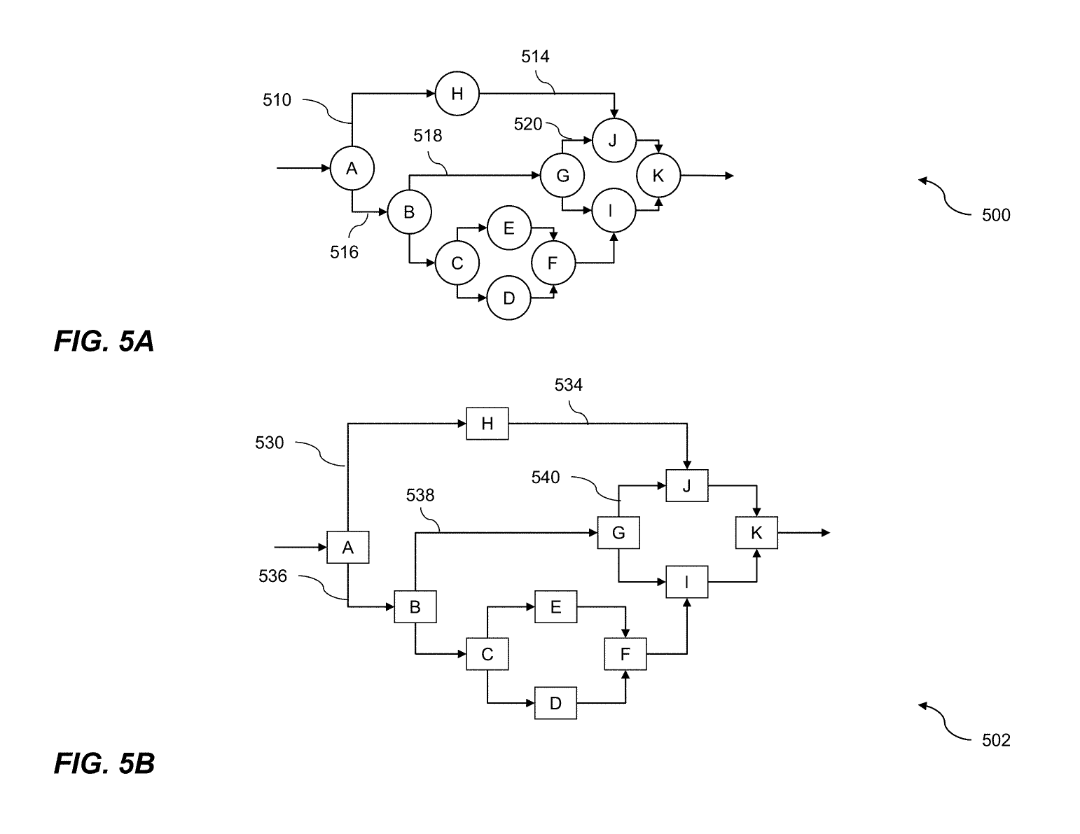

FIG. 5A shows an initial dataflow graph 500 with a moveable agent. The flow graph 500 can represent information regarding various computation points within a reconfigurable networked node processing system. The reconfiguring can enable implementation of a dataflow graph. In embodiments, each node within the flow graph 500 can be represented by a processing element. The flow can include transferring a first data between the first processing element and the second processing element. As can be seen in FIG. 5A, there is a path 510 between node A and node H, and path 514 between node H and node J. Similarly, there is a path 516 between node A and node B, a path 518 between node B and node G, and a path 520 between node G and node J. Thus, there are two paths between node A and node J. The first path between node A and node J uses path 510 and path 514 via node H. The second path between node A and node J uses path 516, 518, and 520 via nodes B and G. In embodiments, a compiler may accept a flow graph as an input to generate a configuration of processing elements and FIFOs.

FIG. 5B shows a diagram 502 depicting an interconnection of processing elements with initial agent placement. As similarly described for FIG. 5A, there is a path 530 between processing element A and processing element H, and path 534 between processing element H and processing element J. Similarly, there is a path 536 between processing element A and processing element B, a path 538 between processing element B and processing element G, and a path 540 between processing element G and processing element J. Thus, there are two paths between processing element A and processing element J. The first path between processing element A and processing element J uses path 530 and path 534 via processing element H. The second path between processing element A and processing element J uses path 536, 538, and 540 via processing elements B and G. In some situations, arrival time of data at processing element J from both paths may need to be optimized such that data arrives within a predetermined time window. Thus there can be latency requirements within the reconfigurable network of processing elements. In embodiments, the latency requirements may be handled via one or more FIFOs configured between one or more pairs of processing elements. In embodiments, there are at least three processing elements, each executing a process agent and two FIFOs, where the first FIFO is configured between the first processing element and the second processing element, and where the second FIFO is configured between the second processing element and the third processing element, where the first FIFO has a first size and the second FIFO has a second size. In embodiments, the first size is bigger based on latency requirements of the first process agent and the second process agent. In other embodiments, the second size is bigger based on latency requirements of the second process agent and the third process agent.

In some embodiments, one or more agents may be disabled and/or enabled during the course of a computation being executed. For example, if path 530 is a fast path, and path 534 is a slower path, then a FIFO may be established to have data written from processing element A, and read from processing element H. Thus, a process agent may be executing on processing element A and processing element H in order to enable data transfer using such a FIFO. In some cases, during the course of execution, the processing elements executing a process agent may change. For example, if processing element A produces large amounts of bursty data destined for processing element H as part of an initialization sequence, the FIFO between processing elements A and H may only be needed for the initial portion of the computation process. Once the initial portion has been completed, the transfer of the bursty data stops and the process agents executing on processing elements A and H can enter sleep mode to save power. If, at a second phase of the computation, large amounts of bursty data are generated by processing element B which is destined for processing element G, then process agents can be dynamically activated to operate on processing element B and processing element G, with a FIFO configured between B and G. Thus, embodiments can include dynamic activation and deactivation of process agents. Process agents therefore may be “moveable” in that during the course of execution, the processing elements that are executing process agents can change. In some embodiments, every processing element may have a process agent initialized and placed in an idle mode as part of an initialization process. FIFOs may be dynamically allocated as needed based on latency, synchronization, and/or performance requirements. In embodiments, instructions provided to circular buffers within each processing element take the corresponding process agent out of the idle state to begin transferring data to/from FIFOs.

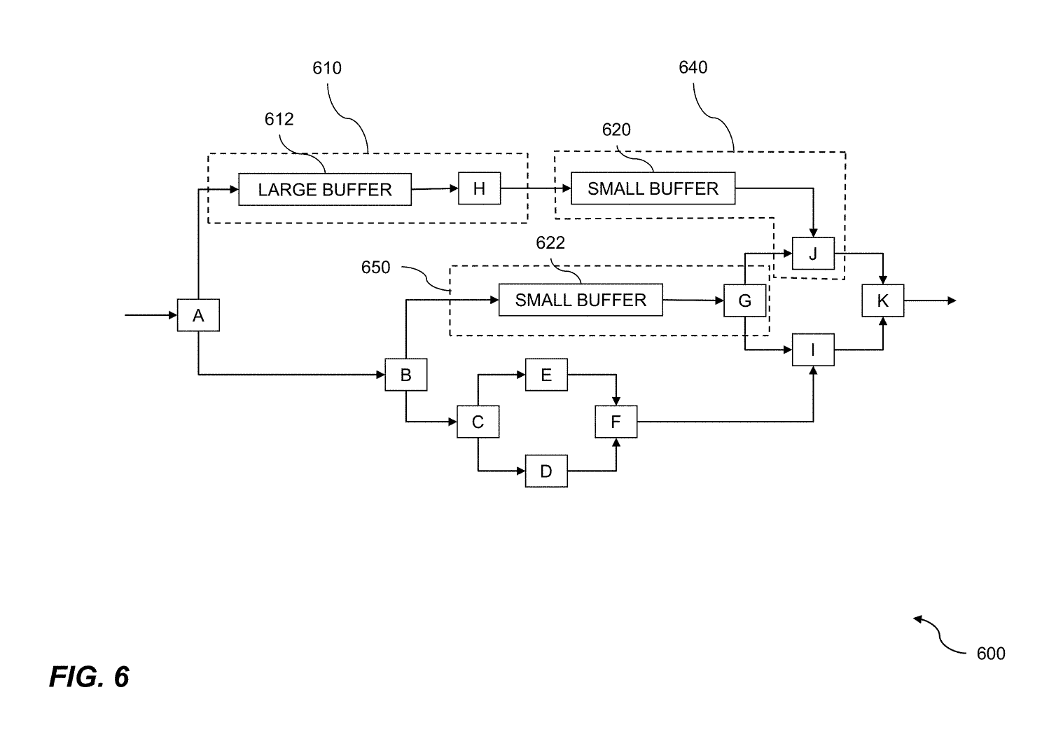

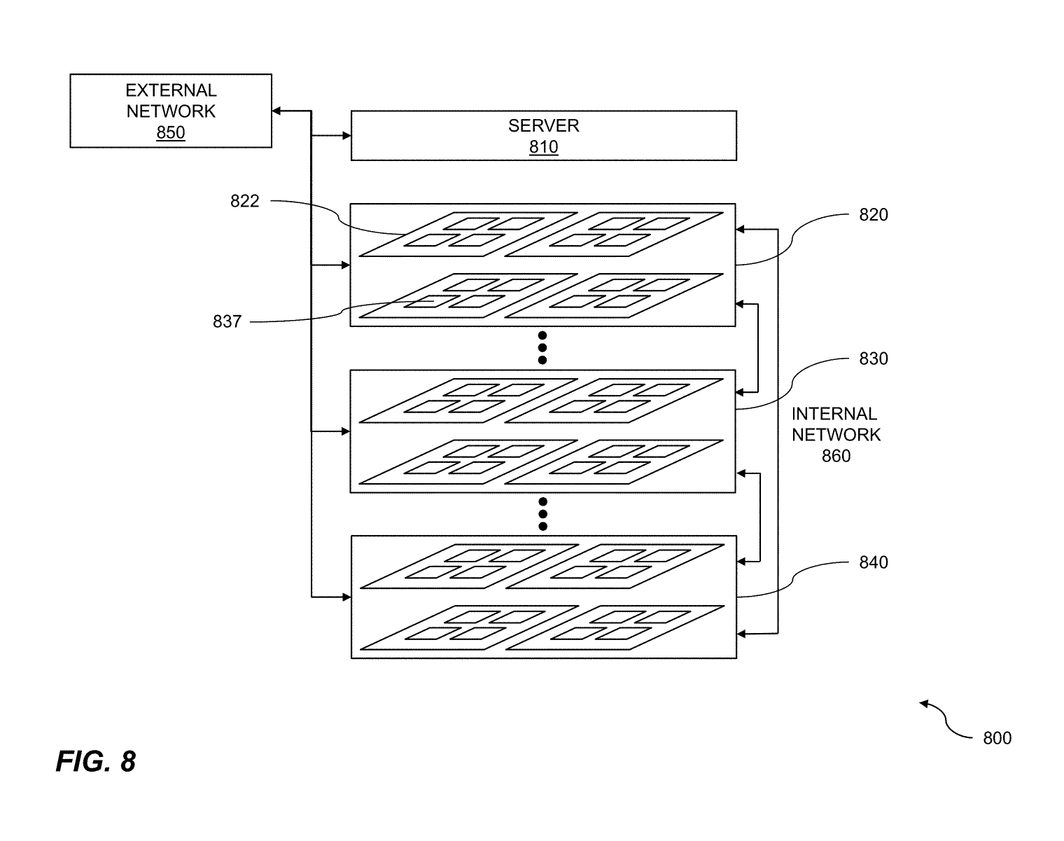

FIG. 6 illustrates an example 600 of managed agent placement and buffer allocation. As shown in example 600, segment 610 includes a large buffer 612 and processing element H. Segment 640 includes a small buffer 620 and processing element J. Segment 650 includes a small buffer 622 and processing element G. The buffers 612, 620, and 622 can be configured as FIFOs. The large buffer 612 may have a first size and the small buffers 620 and 622 may have a second size. The first size and the second size can be different. In some embodiments, the size of the buffers 612, 620, and 622 may change dynamically based on operating conditions. The operating conditions can include an input data rate, as well as current total memory requirements. For example, if more memory is needed elsewhere within the reconfigurable fabric for enabling the configuration of FIFOs between other processing elements, then the size of the large buffer 612 may be reduced to free up memory for configuration of those FIFOs. In embodiments, one of the processing elements A-K may serve as an allocation manager to keep track of memory available for FIFOs. For example, if processing element E is an allocation manager, then as processing element G alters its FIFO requirements, processing element E is notified of the requested changes. In embodiments, the allocation manager processing element may approve the allocations and deallocations of memory for FIFOs. In some embodiments, an external computer such as a server may be connected to the network of processing elements, and perform functions of an allocation manager (see server 810 of FIG. 8).

In embodiments, the arrangement of processing elements and FIFOs may be grouped into segments for the purposes of temporal analysis. Each segment can be modeled as having an input rate and an output rate. For example, segment 610, comprising buffer 612 and processing element H, has a data output rate of data that is then input to segment 640. Each segment rate is a function of a buffer size and a processing element. To alter the data rate, the size of a FIFO may be changed, and/or instructions within circular buffers of the processing element may be changed to modify the data rate and/or burstiness of the data. In some embodiments, automated tools such as compilers may perform optimizations based on analysis of the segments.

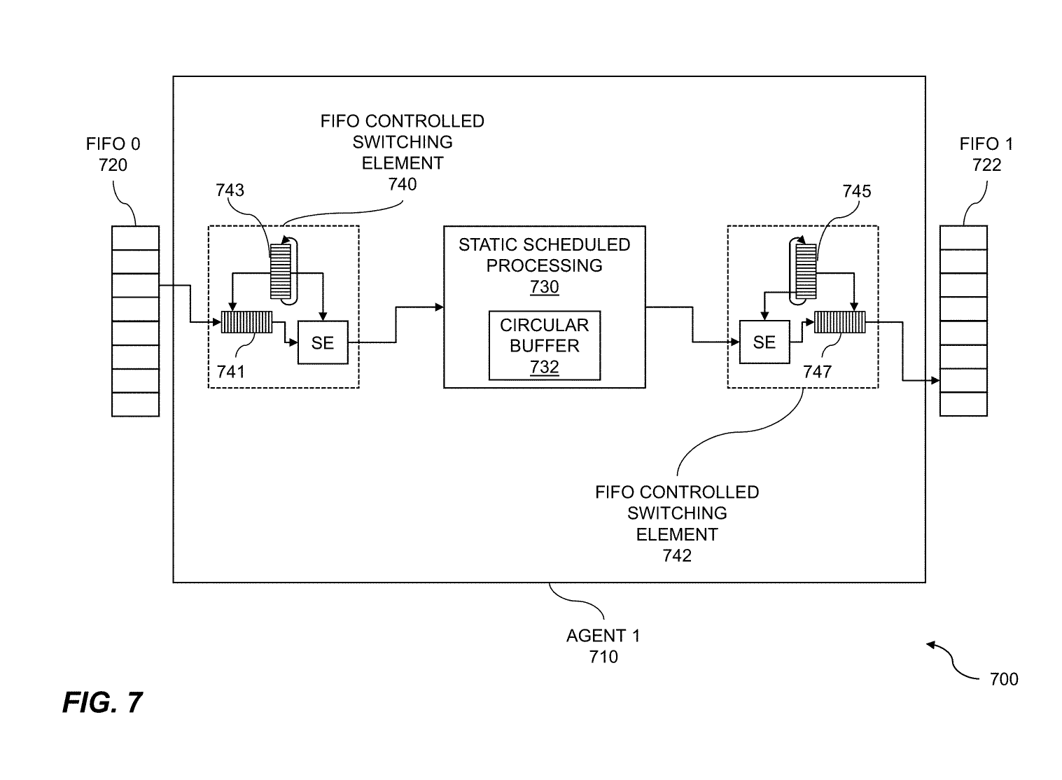

FIG. 7 shows an example 700 of scheduled sections relating to an agent. A FIFO 720 serves as an input FIFO for a process agent 710. Data from FIFO 720 is read into a local buffer 741 of a FIFO controlled switching element 740. A circular buffer 743 may contain instructions that are executed by a switching element (SE), and may modify data based on one or more logical operations, including, but not limited to, XOR, OR, AND, NAND, and/or NOR. The plurality of processing elements can be controlled by circular buffers. The modified data may be passed to a circular buffer 732 under static scheduled processing 730. Thus, the scheduling of circular buffer 732 may be performed at compile time. The circular buffer 732 may provide data to a FIFO controlled switching element 742. Circular buffer 745 may rotate to provide a plurality of instructions/operations to modify and/or transfer data to a data buffer 747, which is then transferred to external FIFO 722.

A process agent can include multiple components. An input component handles retrieval of data from an input FIFO. For example, AGENT1 710 receives input from FIFO0 720. An output component handles the sending of data to an output FIFO. For example, AGENT1 710 provides data to FIFO1 722. A signaling component can signal process agents executing on neighboring processing elements about conditions of a FIFO. For example, a process agent can issue a FIRE signal to another process agent operating on another processing element when new data is available in a FIFO that was previously empty. Similarly, a process agent can issue a DONE signal to another process agent operating on another processing element when new space is available in a FIFO that was previously full. In this way, the process agent facilitates communication of data and FIFO states amongst neighboring processing elements to enable complex computations with multiple processing elements in an interconnected topology.

Dataflow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Dataflow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on dataflow processors. The dataflow processor can receive a dataflow graph such as an acyclic dataflow graph, where the dataflow graph can represent a deep learning network. The dataflow graph can be assembled at runtime, where assembly can include input/output, memory input/output, and so on. The assembled dataflow graph can be executed on the dataflow processor.

The dataflow processors can be organized in a variety of configurations. One configuration can include processing element quads with arithmetic units. A dataflow processor can include one or more processing elements (PEs). The processing elements can include a processor, a data memory, an instruction memory, communications capabilities, and so on. Multiple PEs can be grouped, where the groups can include pairs, quads, octets, etc. The PEs organized in arrangements such as quads and can be coupled to arithmetic units, where the arithmetic units can be coupled to or included in data processing units (DPU). The DPUs can be shared between and among quads. The DPUs can provide arithmetic techniques to the PEs, communications between quads, and so on.

The dataflow processors, including dataflow processors arranged in quads, can be loaded with kernels. The kernels can be included in a dataflow graph, for example. In order for the dataflow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value −1 plus the Manhattan distance from a given PE in a cluster to the end of the cluster. A Manhattan distance can include a number of steps to the east, west, north, and south. A control signal can be propagated from the start cluster to the end cluster. The control signal advances 1 cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Various techniques, including direct memory access (DMA) can be used to load instructions from the kernel into instruction memories of the PEs. The clusters that were pre-programmed into configuration mode can be preprogrammed to exit configuration mode. When configuration mode has been exited, execution of the one or more kernels loaded onto the clusters can commence.

Dataflow processes that can be executed by dataflow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include dataflow partitioning, dataflow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a dataflow processor can include precompiled software or agent generation. The pre-compiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the dataflow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a dataflow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

FIG. 8 illustrates an example of a system 800 including a server 810 allocating FIFOs and processing elements. In embodiments, system 800 includes one or more boxes, indicated as 820, 830, and 840. Each box may have one or more boards, indicated generally as 822. Each board comprises one or more chips, indicated generally as 837. Each chip may include one or more processing elements, where at least some of the processing elements may execute a process agent. An internal network 860 allows communication between the boxes, such that processing elements on one box can provide and/or receive results from processing elements on another box.

The server 810 may be a computer executing programs on one or more processors based on instructions contained in a non-transitory computer readable medium. The server 810 may perform reconfiguring of a mesh networked computer system comprising a plurality of processing elements with a FIFO between one or more pairs of processing elements. In some embodiments, each pair of processing elements has a dedicated FIFO configured to pass data between the processing elements of the pair. The server 810 may receive instructions and/or input data from external network 850. The external network may provide information that includes, but is not limited to, hardware description language instructions (e.g. Verilog, VHDL, or the like), flow graphs, source code, or information in another suitable format.

The server 810 may collect performance statistics on the operation of the collection of processing elements. The performance statistics can include average sleep time of a processing element and/or a histogram of the sleep time of each processing element. Any outlier processing elements that sleep longer than a predetermined time frame threshold can be identified. In embodiments, the server can resize FIFOs or create new FIFOs to reduce the sleep time of a processing element that exceeds the predetermined threshold. Sleep time is essentially time when a processing element is not producing meaningful results, so it is generally desirable to minimize the amount of time that a processing element spends in a sleep mode. In some embodiments, the server 810 may serve as an allocation manager to process requests for adding or freeing FIFOs, and/or changing the size of existing FIFOs in order to optimize operation of the processing elements.

In some embodiments, the server may receive optimization settings from the external network 850. The optimization settings may include a setting to optimize for speed, optimize for memory usage, or balance between speed and memory usage. Additionally, optimization settings may include constraints on the topology, such as a maximum number of paths that may enter or exit a processing element, maximum data block size, and other settings. Thus, the server 810 can perform a reconfiguration based on user-specified parameters via external network 850.

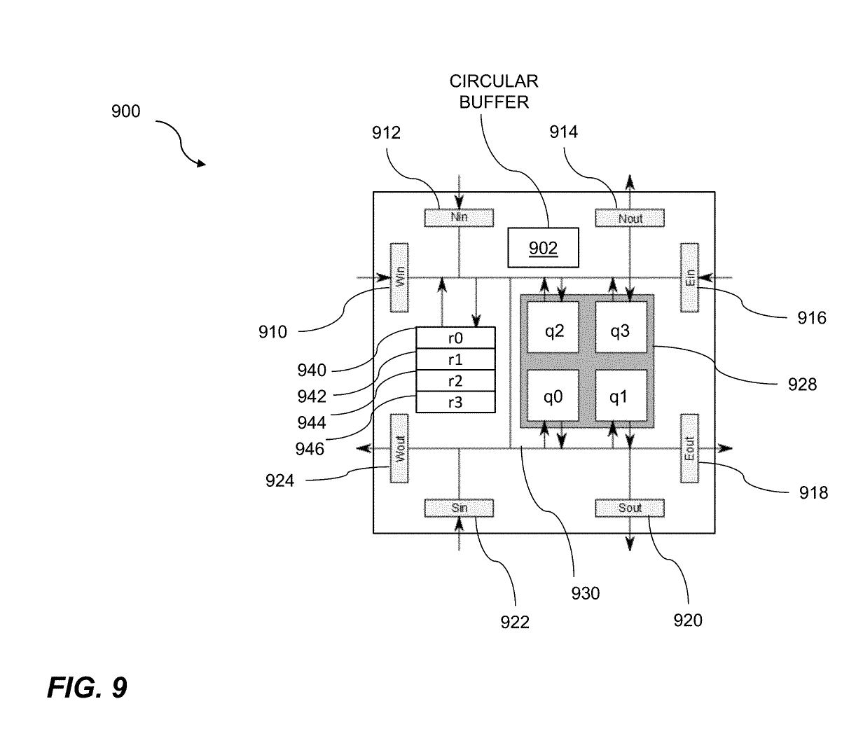

FIG. 9 is an example cluster 900 for coarse-grained reconfigurable processing. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The cluster 900 comprises a circular buffer 902. The circular buffer 902 can be referred to as a main circular buffer or a switch-instruction circular buffer. In some embodiments, the cluster 900 comprises additional circular buffers corresponding to processing elements within the cluster. The additional circular buffers can be referred to as processor instruction circular buffers. The example cluster 900 comprises a plurality of logical elements, configurable connections between the logical elements, and a circular buffer 902 controlling the configurable connections. The logical elements can further comprise one or more of switching elements, processing elements, or storage elements. The example cluster 900 also comprises four processing elements—q0, q1, q2, and q3. The four processing elements can collectively be referred to as a “quad,” and jointly indicated by a grey reference box 928. In embodiments, there is intercommunication among and between each of the four processing elements. In embodiments, the circular buffer 902 controls the passing of data to the quad of processing elements through switching elements. In embodiments, the four processing elements comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 900 can further comprise storage elements coupled to the configurable connections. As shown, the cluster 900 comprises four storage elements: r0 940, r1 942, r2 944, and r3 946. The cluster 900 further comprises a north input (Nin) 912, a north output (Nout) 914, an east input (Ein) 916, an east output (Eout) 918, a south input (Sin) 922, a south output (Sout) 920, a west input (Win) 910, and a west output (Wout) 924. The circular buffer 902 can contain switch instructions that implement configurable connections. For example, an instruction effectively connects the west input 910 with the north output 914 and the east output 918 and this routing is accomplished via bus 930. The cluster 900 can further comprise a plurality of circular buffers residing on a semiconductor chip where the plurality of circular buffers control unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 902. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 924 to an instruction placing data on the south output 920, such that the data can be output on both output ports within the same pipeline cycle. In a case where data needs to travel to a cluster that is both south and west of the cluster 900, it can be more efficient to send the data directly to the south output port rather than to store the data in a register first, and then send the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch input operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a mem bit is set to ‘1’ for both inputs, an output mem bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during the configuration mode. The quad RAMs may have a single read/write port with a single address decoder, thus allowing access to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

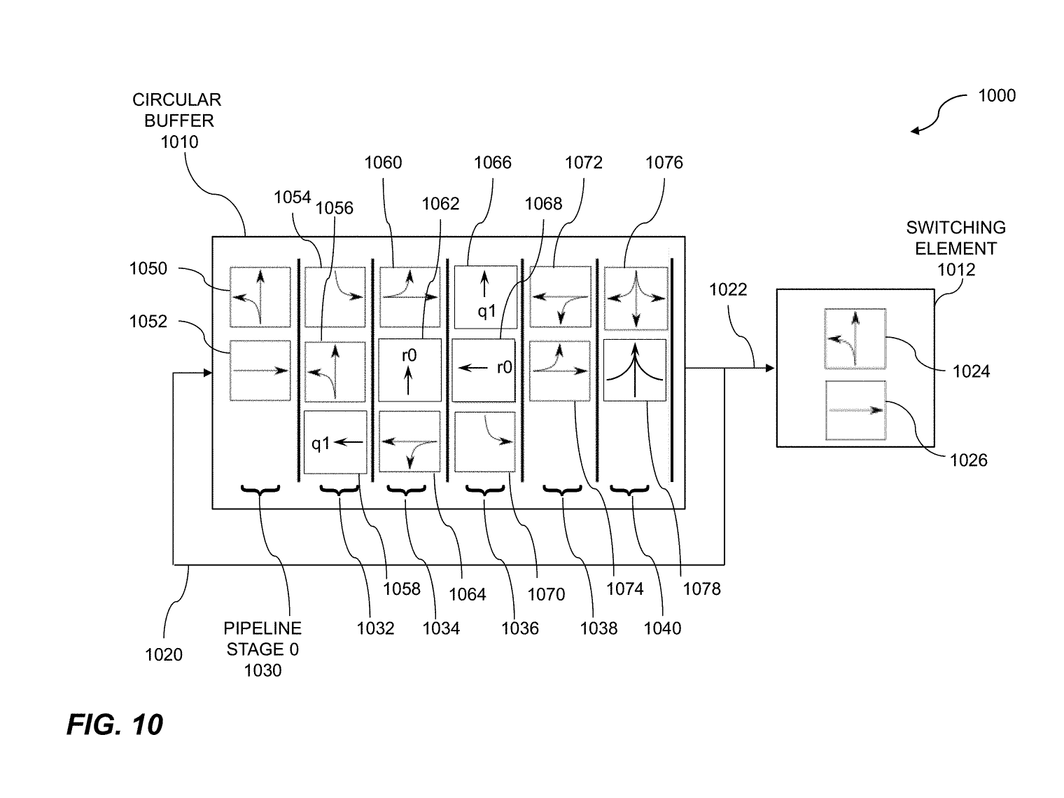

FIG. 10 shows a block diagram of a circular buffer. The circular buffer 1010 can include a switching element 1012 corresponding to the circular buffer. The circular buffer and the corresponding switching element can be used in part for dynamic reconfiguration with partially resident agents. Using the circular buffer 1010 and the corresponding switching element 1012, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1000 describes a processor-implemented method for data manipulation. The circular buffer 1010 contains a plurality of pipeline stages. Each pipeline stage contains one or more instructions, up to a maximum instruction depth. In the embodiment shown in FIG. 10, the circular buffer 1010 is a 6×3 circular buffer, meaning that it implements a six-stage pipeline with an instruction depth of up to three instructions per stage (column). Hence, the circular buffer 1010 can include one, two, or three switch instruction entries per column. In some embodiments, the plurality of switch instructions per cycle can comprise two or three switch instructions per cycle. However, in certain embodiments, the circular buffer 1010 supports only a single switch instruction in a given cycle. In the block diagram example 1000 shown, Pipeline Stage 0 1030 has an instruction depth of two instructions 1050 and 1052. Though the remaining pipeline stages 1-5 are not textually labeled in FIG. 10, the stages are indicated by callouts 1032, 1034, 1036, 1038, and 1040. Pipeline stage 1 1032 has an instruction depth of three instructions 1054, 1056, and 1058. Pipeline stage 2 1034 has an instruction depth of three instructions 1060, 1062, and 1064. Pipeline stage 3 1036 also has an instruction depth of three instructions 1066, 1068, and 1070. Pipeline stage 4 1038 has an instruction depth of two instructions 1072 and 1074. Pipeline stage 5 1040 has an instruction depth of two instructions 1076 and 1078. In embodiments, the circular buffer 1010 includes 64 columns. During operation, the circular buffer 1010 rotates through configuration instructions. The circular buffer 1010 can dynamically change operation of the logical elements based on the rotation of the circular buffer. The circular buffer 1010 can comprise a plurality of switch instructions per cycle for the configurable connections.

The instruction 1052 is an example of a switch instruction. In embodiments, each cluster has four inputs and four outputs, each designated within the cluster's nomenclature as “north,” “east,” “south,” and “west” respectively. For example, the instruction 1052 in the block diagram 1000 is a west-to-east transfer instruction. The instruction 1052 directs the cluster to take data on its west input and send out the data on its east output. In another example of data routing, the instruction 1050 is a fan-out instruction. The instruction 1050 instructs the cluster to take data from its south input and send out on the data through both its north output and its west output. The arrows within each instruction box indicate the source and destination of the data. The instruction 1078 is an example of a fan-in instruction. The instruction 1078 takes data from the west, south, and east inputs and sends out the data on the north output. Therefore, the configurable connections can be considered to be time multiplexed.

In embodiments, the clusters implement multiple storage elements in the form of registers. In the block diagram example 1000 shown, the instruction 1062 is a local storage instruction. The instruction 1062 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1058 is a processing instruction. The instruction 1058 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1000 shown, the circular buffer 1010 rotates instructions in each pipeline stage into switching element 1012 via a forward data path 1022, and also back to a pipeline stage 0 1030 via a feedback data path 1020. Instructions can include switching instructions, storage instructions, and processing instructions, among others. The feedback data path 1020 can allow instructions within the switching element 1012 to be transferred back to the circular buffer. Hence, the instructions 1024 and 1026 in the switching element 1012 can also be transferred back to pipeline stage 0 as the instructions 1050 and 1052. In addition to the instructions depicted on FIG. 10, a no-op instruction can also be inserted into a pipeline stage. In embodiments, a no-op instruction causes execution to not be performed for a given cycle. In effect, the introduction of a no-op instruction can cause a column within the circular buffer 1010 to be skipped in a cycle. By contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs causing the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus which is external to the logical element and not based on the programming of the logical element. The external stimulus can include an input signal, which in turn can cause a wake up or an interrupt service request to execute on one or more of the logical elements. An example of such a wake-up request can be seen in the instruction 1058, assuming that the processor q1 was previously in a sleep state. In embodiments, when the instruction 1058 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1066. In the case of the instruction 1066, data from the processor q1 is moved to the north output. In some embodiments, if Xs have been placed into the processor q1, such as during the instruction 1058, then Xs would be retrieved from the processor q1 during the execution of the instruction 1066 and applied to the north output of the instruction 1066.

A collision occurs if multiple instructions route data to a particular port in a given pipeline stage. For example, if instructions 1052 and 1054 are in the same pipeline stage, they will both send data to the east output at the same time, thus causing a collision since neither instruction is part of a time-multiplexed fan-in instruction (such as the instruction 1078). To avoid potential collisions, certain embodiments use pre-processing, such as by a compiler, to arrange the instructions in such a way that there are no collisions when the instructions are loaded into the circular buffer. The circular buffer 1010 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the pre-processor can insert further instructions such as storage instructions (e.g. the instruction 1062), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0 and will thereby prevent a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

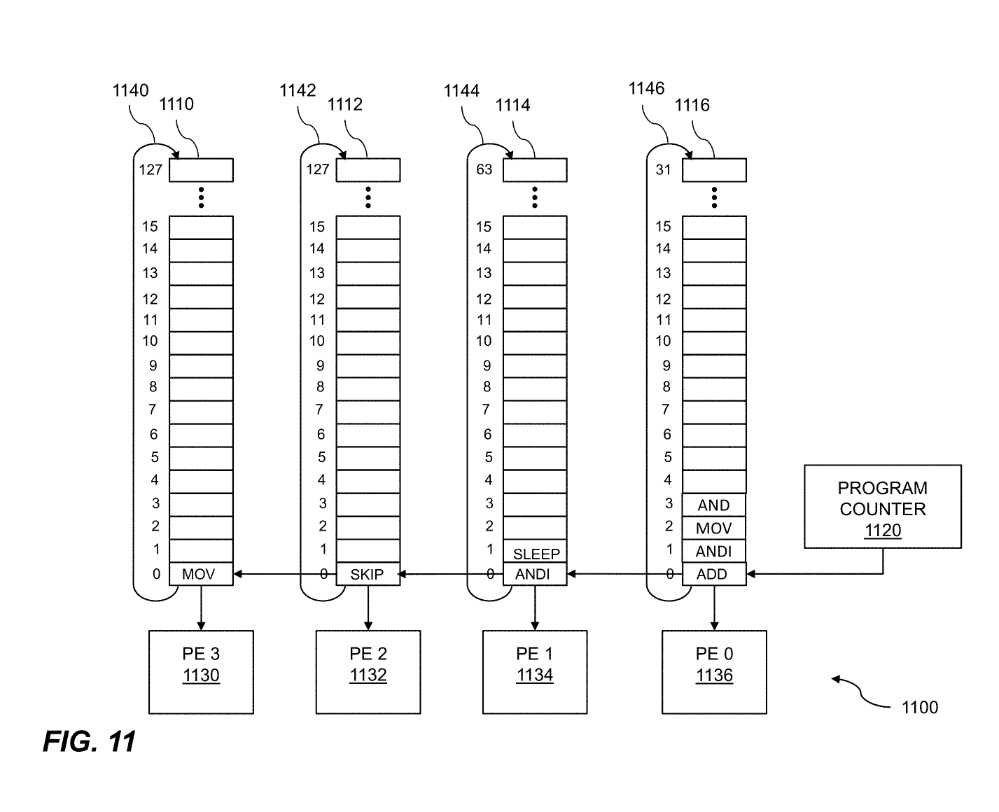

FIG. 11 shows example circular buffers and processing elements. This figure shows a diagram 1100 indicating example instruction execution for processing elements. A first circular buffer 1110 feeds a processing element 1130. A second circular buffer 1112 feeds another processing element 1132. A third circular buffer 1114 feeds another processing element 1134. A fourth circular buffer 1116 feeds another processing element 1136. The four processing elements 1130, 1132, 1134, and 1136 can represent a quad of processing elements. In embodiments, the processing elements 1130, 1132, 1134, and 1136 are controlled by instructions received from the circular buffers 1110, 1112, 1114, and 1116. The circular buffers can be implemented using feedback paths 1140, 1142, 1144, and 1146, respectively. In embodiments, the circular buffer can control the passing of data to a quad of processing elements through switching elements, where each of the quad of processing elements is controlled by four other circular buffers (as shown in the circular buffers 1110, 1112, 1114, and 1116) and where data is passed back through the switching elements from the quad of processing elements where the switching elements are again controlled by the main circular buffer. In embodiments, a program counter 1120 is configured to point to the current instruction within a circular buffer. In embodiments with a configured program counter, the contents of the circular buffer are not shifted or copied to new locations on each instruction cycle. Rather, the program counter 1120 is incremented in each cycle to point to a new location in the circular buffer. The circular buffers 1110, 1112, 1114, and 1116 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 1110 and 1112 have a length of 128 instructions, the circular buffer 1114 has a length of 64 instructions, and the circular buffer 1116 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 11, different circular buffers can have different instruction sets within them. For example, circular buffer 1110 contains a MOV instruction. Circular buffer 1112 contains a SKIP instruction. Circular buffer 1114 contains a SLEEP instruction and an ANDI instruction. Circular buffer 1116 contains an AND instruction, a MOVE instruction, an ANDI instruction, and an ADD instruction. The operations performed by the processing elements 1130, 1132, 1134, and 1136 are dynamic and can change over time based on the instructions loaded into the respective circular buffers. As the circular buffers rotate, new instructions can be executed by the respective processing element.

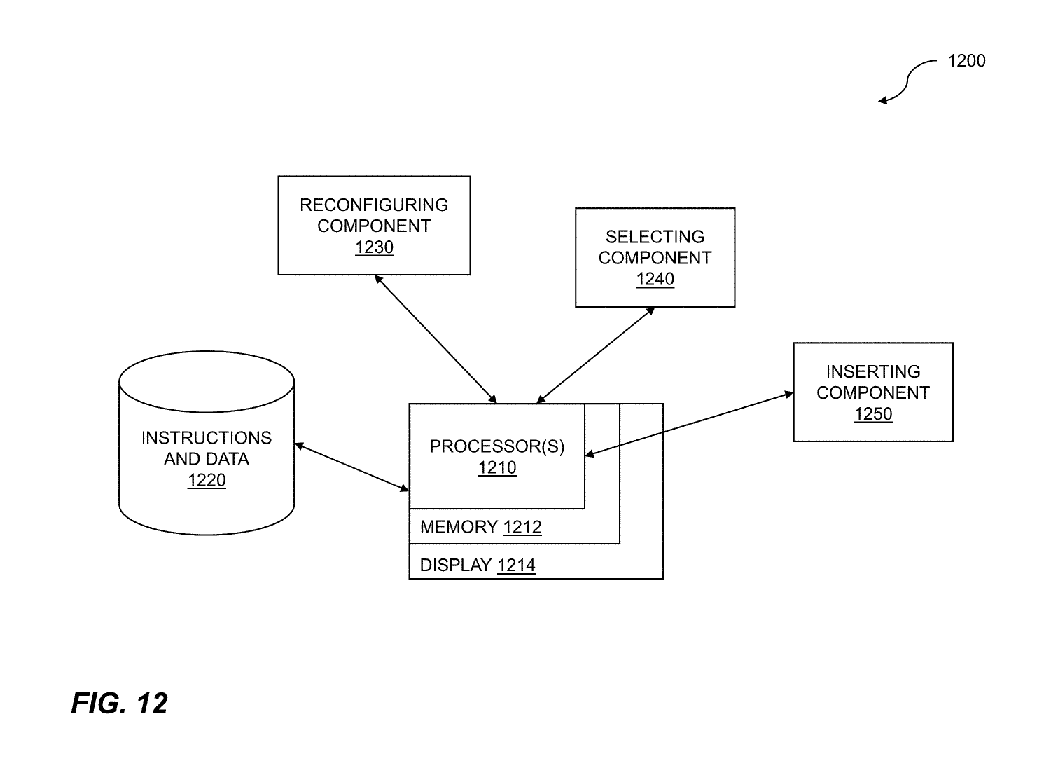

FIG. 12 is a system diagram for implementing computational reconfiguration using FIFOs. The system 1200 can include one or more processors 1210 coupled to a memory 1212 which stores instructions. The system 1200 can include a display 1214 coupled to the one or more processors 1210 for displaying data, intermediate steps, instructions, and so on. In embodiments, one or more processors 1210 are attached to the memory 1212 where the one or more processors, when executing the instructions which are stored, are configured to: reconfigure a plurality of processing elements to perform operations of a plurality of process agents wherein the plurality of process agents includes a first process agent assigned to a first processing element and a second process agent assigned to a second processing element and a third process agent assigned to a third processing element; select a first size for a first FIFO memory element and a second size for a second FIFO memory element, wherein the selecting is based on the first process agent, the second process agent, and the third process agent; insert the first FIFO between the first processing element and the second processing element; and insert the second FIFO memory element between the second processing element and the third processing element.

The system 1200 can include a collection of instructions and data 1220. The instructions and data 1220 may be stored in a database, in one or more statically linked libraries, one or more dynamically linked libraries, as precompiled headers, as source code, as flow graphs, or in other suitable formats. System 1200 can include a reconfiguring component 1230. The reconfiguring component 1230 can include functions and instructions for reconfiguring a computing system comprising multiple processing elements. The reconfiguring can include establishing a mesh size, and/or establishing an initial placement of process agents. The system 1200 can include a selecting component 1240. The selecting component 1240 can include functions and instructions for establishing an initial size of one or more FIFOs. In embodiments, the selecting component selects a first size for a first FIFO memory element and a second size for a second FIFO memory element. The system 1200 can include an inserting component 1250. The inserting component 1250 can include functions and instructions for inserting a FIFO between a pair of processing elements. In embodiments, the inserting component inserts a first FIFO between a first processing element and a second processing element, and inserts a second FIFO between the second processing element and a third processing element.

The system 1200 can comprise a computer program product embodied in a non-transitory computer readable medium for data manipulation, the computer program product comprising code which causes one or more processors to perform operations of: reconfiguring a plurality of processing elements to perform operations of a plurality of process agents wherein the plurality of process agents includes a first process agent assigned to a first processing element and a second process agent assigned to a second processing element and a third process agent assigned to a third processing element; selecting a first size for a first FIFO memory element and a second size for a second FIFO memory element, wherein the selecting is based on the first process agent, the second process agent, and the third process agent; inserting the first FIFO between the first processing element and the second processing element; and inserting the second FIFO memory element between the second processing element and the third processing element.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data manipulation comprising:
reconfiguring a plurality of processing elements to perform operations of a plurality of process agents wherein the plurality of process agents includes a first process agent assigned to a first processing element and a second process agent assigned to a second processing element and a third process agent assigned to a third processing element;
selecting a first size for a first FIFO memory element and a second size for a second FIFO memory element, wherein the selecting is based on the first process agent, the second process agent, and the third process agent;
inserting the first FIFO memory element between the first processing element and the second processing element; and
inserting the second FIFO memory element between the second processing element and the third processing element.

2. The method of claim 1 further comprising transferring a first data between the first processing element and the second processing element.

3. The method of claim 2 further comprising transferring a second data between the second processing element and the third processing element.

4. The method of claim 3 wherein the first data and the second data are the same.

5. The method of claim 3 wherein the first data and the second data are different.

6. The method of claim 1 wherein the first size and the second size are the same.

7. The method of claim 1 wherein the first size and the second size are different.

8. The method of claim 7 wherein the first size is bigger based on latency requirements of the first process agent and the second process agent.

9. The method of claim 7 wherein the second size is bigger based on latency requirements of the second process agent and the third process agent.

10. The method of claim 1 wherein the first FIFO enables synchronization between the first process agent and the second process agent.

11. The method of claim 1 wherein the second FIFO enables synchronization between the second process agent and the third process agent.

12. The method of claim 1 wherein the reconfiguring enables implementation of a dataflow graph.

13. The method of claim 1 wherein the plurality of processing elements are controlled by circular buffers.

14. The method of claim 13 wherein each of the plurality of processing elements is controlled by a unique circular buffer.

15. The method of claim 13 wherein circular buffers are statically scheduled.

16. The method of claim 1 wherein the FIFOs comprise blocks of memory designated by starting addresses and ending addresses.

17. The method of claim 16 wherein the starting addresses and the ending addresses are stored with instructions in circular buffers.

18. The method of claim 1 wherein the plurality of process agents is triggered by start instructions stored in circular buffers.

19. The method of claim 1 wherein the second process agent issues a first done signal to the first process agent when the second process agent has completed a first data transfer out of the first FIFO.

20. The method of claim 1 wherein the third process agent issues a second done signal to the second process agent when the third process agent has completed a second data transfer out of the second FIFO.

21. The method of claim 1 wherein the processing elements enter a sleep mode when there is no data to transfer.

22. The method of claim 21 wherein the processing elements exit the sleep mode when presented with valid data.

23. The method of claim 21 wherein the processing elements do not exit the sleep mode when presented with invalid data.

24. The method of claim 21 wherein the sleep mode is a low power mode.

25. The method of claim 1 wherein the plurality of processing elements comprise a reconfigurable fabric.

26. The method of claim 1 wherein the plurality of processing elements comprise a dataflow processor.

27. A computer program product embodied in a non-transitory computer readable medium for data manipulation, the computer program product comprising code which causes one or more processors to perform operations of:
reconfiguring a plurality of processing elements to perform operations of a plurality of process agents wherein the plurality of process agents includes a first process agent assigned to a first processing element and a second process agent assigned to a second processing element and a third process agent assigned to a third processing element;
selecting a first size for a first FIFO memory element and a second size for a second FIFO memory element, wherein the selecting is based on the first process agent, the second process agent, and the third process agent;
inserting the first FIFO between the first processing element and the second processing element; and
inserting the second FIFO memory element between the second processing element and the third processing element.

28. A computer system for data manipulation comprising:
a memory which stores instructions;
one or more processors attached to the memory wherein the one or more processors, when executing the instructions which are stored, are configured to:
reconfigure a plurality of processing elements to perform operations of a plurality of process agents wherein the plurality of process agents includes a first process agent assigned to a first processing element and a second process agent assigned to a second processing element and a third process agent assigned to a third processing element;
select a first size for a first FIFO memory element and a second size for a second FIFO memory element, wherein the selecting is based on the first process agent, the second process agent, and the third process agent;
insert the first FIFO between the first processing element and the second processing element; and
insert the second FIFO memory element between the second processing element and the third processing element.
